(19) United States
(12) Patent Application Publication
(10) Pub. No.: US 2006/0265472 A1
(43) Pub. Date: Nov. 23, 2006

(54) Systems and methods for providing short message service features and user interfaces therefor in network browsing applications

(75) Inventors: Edward Seitz, Atlanta, GA (US); Derrick Whittle, Marietta, GA (US); Robert Gue, Atlanta, GA (US); Stephen Owens, Marietta, GA (US); Brockton Davis, Marietta, GA (US); James Bollas, Columbus, OH (US); Michael Wolford, Roswell, GA (US)

Correspondence Address: GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/434,935

(22) Filed: May 17, 2006

Related U.S. Application Data
(60) Provisional application No. 60/681,458, filed on May 17, 2005.

(51) Int. Cl. G06F 15/16

(52) U.S. Cl. 709/217

(57) ABSTRACT

A method of transferring content between a plurality of devices, one embodiment of the method comprising opening a network browsing application on a first device; identifying content to be transferred to at least one second device; causing a content transfer user interface to be opened on the first device; identifying the at least one second device; and, causing the identified content to be transferred to the at least one identified second device.

This application claims the benefit of U.S. Provisional Application Ser. No. 60/681,458 filed May 17, 2005 entitled Systems and Methods for Providing Features and User Interface in Network Browsing Applications, the disclosure of which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosure relates in general to the field of network browsing-enabled applications, and in particular to systems and methods that provide improved interfaces to Short Message Service (“SMS”) functionality.

### BACKGROUND

In today's computing environment, users have access to a wide array of devices, including, without limitation, desktop computers, laptop computers, personal digital assistants (“PDA's”), pagers, and cellular telephones. Each of the various device types has its strengths and weaknesses. By way of example, laptop computers have the data processing and storage capabilities needed to allow a user to easily access the Internet and the various content available therefrom. However, most laptop computers do not allow users to access cellular telephone networks and place calls using such networks. By contrast, cellular telephones excel at placing and maintaining calls, even as the user moves between locations. However, although many of today's cellular telephones can access the Internet via the cellular telephone network, most Internet content is not formatted for small cellular telephone displays, and cellular telephones do not have the computational and storage capabilities needed to fully access today's Internet content.

Users therefore frequently attempt to move information between more computationally capable and storage-capable devices, such as desktop computers and laptop computers, and less computationally capable and storage-capable devices, such as PDA's, pagers, and cellular phones. This is typically done by “synchronizing” the information between the different devices. Synchronization requires that the devices be actively communicatively coupled. In most cases, this communicative coupling is done by physically connecting one device to another, such as with a Universal Serial Bus (“USB”) cable, although some devices now support wireless synchronization through short-range wireless technologies such as those employing the Bluetooth standard. However, not all devices support synchronization, and in some cases it is not always convenient, or even possible, to synchronize data between devices due to security concerns or other restrictions. By way of example, a user at an Internet café may not wish to synchronize their PDA, pager, cellular telephone, or other device with the café's computer out of fear that the café's computer may infect the user's device with a virus. Similarly, the Internet café may not give the user access to the physical ports that are needed to synchronize the user's device with the café's computer.

The result is that users must find alternative means for moving information between devices. One commonly employed technique is to open content on a desktop or laptop computer and to copy and paste the content into an E-mail. However, this can be an awkward process, and depending on the content being copied, the E-mail may not display properly on the destination device.

What is needed are improved systems and methods for facilitating data transfers between devices, and improved user interfaces therefor.

### SUMMARY

Accordingly, this disclosure is directed to systems and methods for providing SMS features and user interfaces therefor that substantially obviate one or more of the problems due to limitations and disadvantages of the related art.

The disclosure is to provides a method of transferring content between a plurality of devices, and to a computer-readable storage medium containing a set of instructions for a general purpose computer. In an exemplary embodiment, the method and/or computer instructions comprise opening a network browsing application on a first device; identifying content to be transferred to at least one second device; causing a content transfer user interface to be opened on the first device; identifying the at least one second device; and, causing the identified content to be transferred to the at least one identified second device. The content identifying step can include, without limitation, “dragging” a cursor within the network browsing application to select the content. In one embodiment, once the content to be transferred has been identified, a new network browser window can be opened, wherein the identified content is already loaded as part of the body of an SMS message, which the user can edit. The user interface can also allow the user to enter a network identifier, such as a telephone number or Internet Protocol (“IP”) address of the second device. The user interface can also allow the user to identify attributes associated with the second device, such as, without limitation, the carrier providing telecommunications service to the second device, the computing capabilities of the second device, the display capabilities of the second device, or the model number of the second device. Such attributes can be used to ensure that the content is properly formatted for the second device. In another embodiment, the user can right-click and select from a plurality of pre-defined devices. Such device definitions may be structured similar to traditional address book entry, or may be enhancements to traditional address book entries. In one such embodiment, each address book entry may contain attributes about the device associated with that address book entry. By way of example, without limitation, an address book entry for a cellular telephone may include a field identifying the telephone's display resolution or the model number.

Additional features and advantages will be set forth in the description which follows, and in part will be apparent from the description, or may be learned by practice of the disclosed subject matter. The objectives and other advantages will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are incorporated in and constitute a part of this specification, illustrate certain embodiments and, together with the description, serve to explain the principles of at least one embodiment.

In the drawings:

FIG. 1 is a screen capture of an exemplary network browsing application user interface.

FIG. 2 is a screen capture of an alternative exemplary network browsing application user interface.

FIG. 3 is a screen capture of an exemplary network browsing application user interface through which the SMS recipient is defined.

FIG. 4 is a block diagram of an exemplary network architecture supporting the features and user interfaces of an embodiment.

FIG. 5 is a flow diagram of an exemplary method supporting the features of an embodiment.

### DETAILED DESCRIPTION OF EMBODIMENTS

Reference will now be made in detail to various embodiments, examples of which are illustrated in the accompanying drawings.

The disclosed embodiments relate to improved functionality and user interface features for network browsing-enabled applications. Such applications, referred to herein as “browsing applications,” or “network browsing applications” include, e.g., internet browsers, mail programs with browsing capabilities, file-sharing applications, and any application which provides the capability to browse resources either on an external network (e.g., the internet) or an internal network. Such applications may be separate from or integrated into an operating system.

The functionality of the embodiments described herein can be provided in the form of add-ons or plug-ins to an existing browsing application such as a web browser, but can alternatively be provided in the form of features written into a browsing application at the application's source code level. In certain embodiments, one or more of the features or functionality described below are provided as a compiled .dll file or series of compiled .dll files which are loaded at startup or runtime in connection with an existing browsing application so as to provide an improved user interface and/or additional functionality to the browsing application. As is set forth in further detail below, one or more of the features or functionality described below can be provided or customized by a feed such as an XML feed which is delivered to the browser upon the occurrence of a triggering event. Such triggering events include, e.g., the loading of the browser into the operating system, a change in user-specific parameters, a time of day, or the like. For load-balancing or other purposes, the triggering of download of the feed can be limited to a certain number of times per day, hour, minute, etc. The triggering event can occur on the client or on a server, and the feed can be requested by the client or pushed to the client from a server. In this respect, “client” as used herein can be either a client browsing application such as a web browser or a client machine in general. An example of such an XML feed is provided in Appendix A and discussed in further detail below.

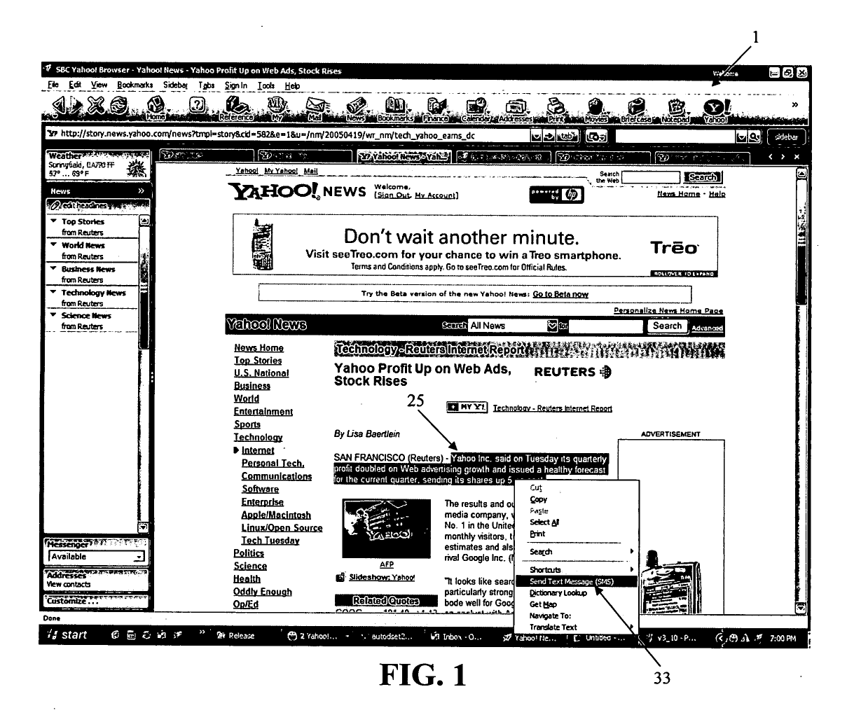

FIGS. 1-3 illustrate exemplary embodiments wherein a browsing application 1 provides the user with the ability to send a block of text 25 via SMS (or other protocols from a page. As illustrated in FIG. 1, one embodiment of browsing application 1 allows the user to highlight or select a block of text 25 on an arbitrary web page, such as by clicking and dragging to select the text. Browsing application 1 can display a send message menu item, such as “Send Text Message (SMS)” menu item 33 when the user right-clicks the highlighted block of text 25 or otherwise invokes the display of a menu. In other embodiments, keyboard shortcuts, additional buttons, or other user interface techniques may be substituted for or used in conjunction with the means discussed above. Although described herein as transferring text content via SMS, other embodiments permit other forms of content, such as photos, videos, audio files (e.g. MP3 files), and other non-text content to be sent from one device to another.

Still further, an embodiment may transmit a Uniform Resource Locator (“URL”) or other such pointer to the content, rather than the actual content itself. This can be useful where the content is to be reformatted based on the capabilities of the device, such as where the size and resolution of an image file is altered based on the display capability of the second, or destination, device, or where the content is alternatively downloaded or streamed to the device based on storage, display, bandwidth, and other capabilities associated with the device. This allows for a great deal of compatibility between older, less capable devices, and newer, more capable devices.

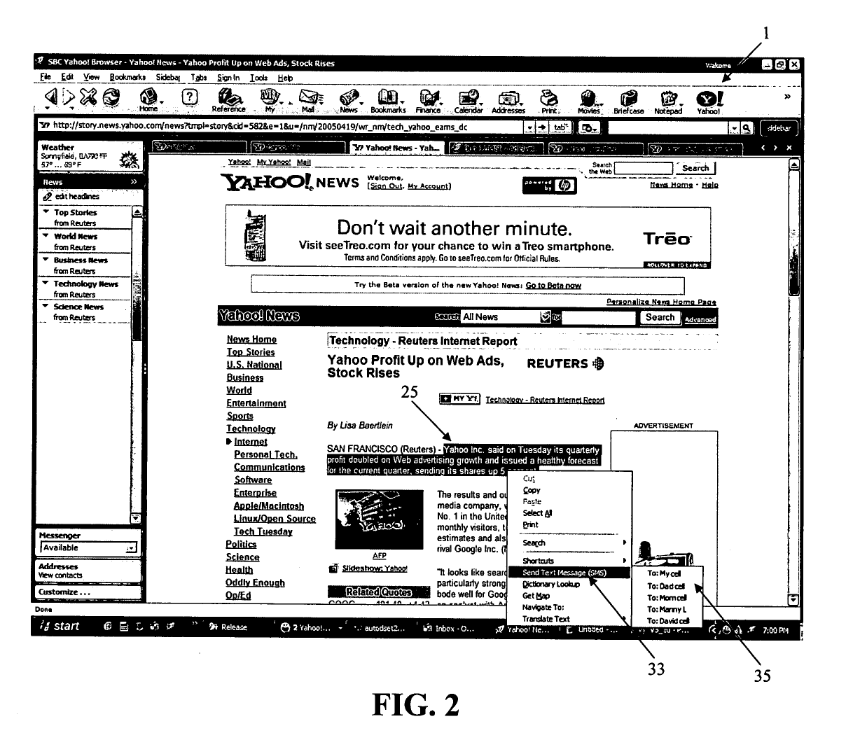

FIG. 2 illustrates an embodiment wherein browsing application 1 can also display one or more SMS sub-menus 35 which specify a particular user, phone number, or device to which to the message will be sent. Browsing application 1 can obtain the contents of such sub-menus from a most-recently-used list, a most-frequently-used list, an address book, or the like maintained by or accessible to browsing application 1.

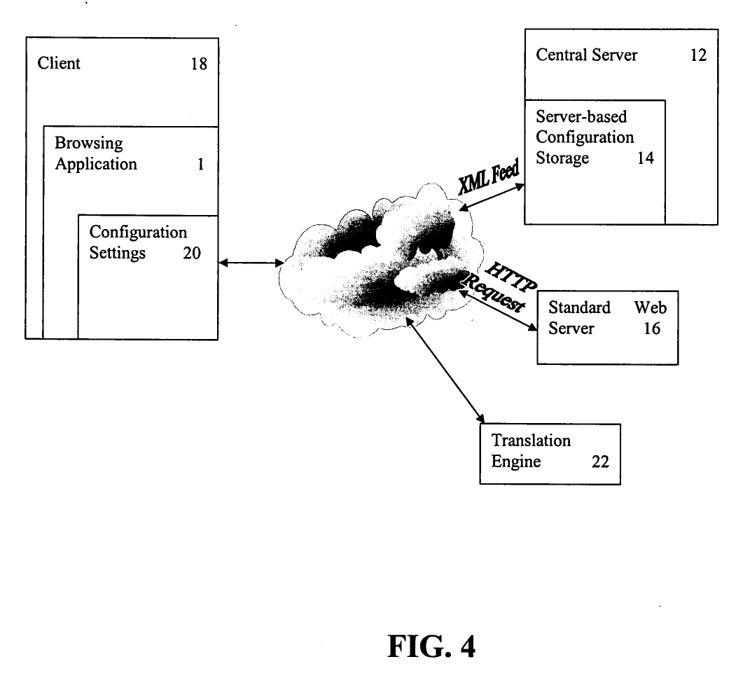

Browsing application 1 may also include processes which permit a user to predefine these menu items, e.g., by displaying a dialog box which allows the user to enter the phone numbers (or other identifier) for each of his contacts into a messaging address book. Alternatively, this address book functionality can be provided by a central server 12 (FIG. 4), such as the well-known address.yahoo.com instead of or in addition to such functionality being provided by browsing application 1. In either case, the user's address book data can be stored electronically on the central server 12 so as to provide access thereto by browsing application 1 independent of which machine or device the user uses for any given session. The messaging address book information can be delivered to the browser by various means, including, e.g., by including it in an XML data feed as described above and illustrated in Appendix A.

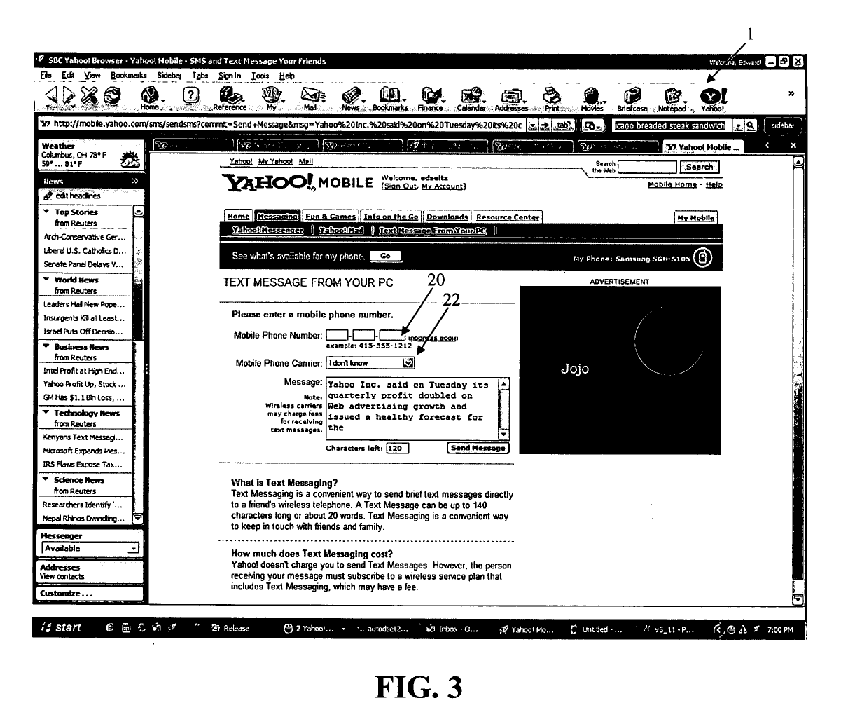

Upon selection of a menu item 33 or sub-menu item 35, one embodiment of browsing application 1 delivers the selected content 25 to an SMS messaging engine, or other type of messaging engine, associated with a web server on the network and displays a page at a URL associated with such an engine. Such messaging engines are well known in the art, and include PageGate SMS server published by Note Page, Inc. of Hanover, Mass. FIG. 3 illustrates an example of browsing application 1 displaying such a page as a result of the SMS send example illustrated in FIG. 1.

In an embodiment, the SMS server is capable of generating a delivery confirmation when the message has been delivered to the recipient or the recipients device. The SMS server can send such a confirmation as an e-mail to the sender, cause browsing application 1 to display a dialog box or other notification for the sender, or use other such techniques to provide the confirmation information to the sender.

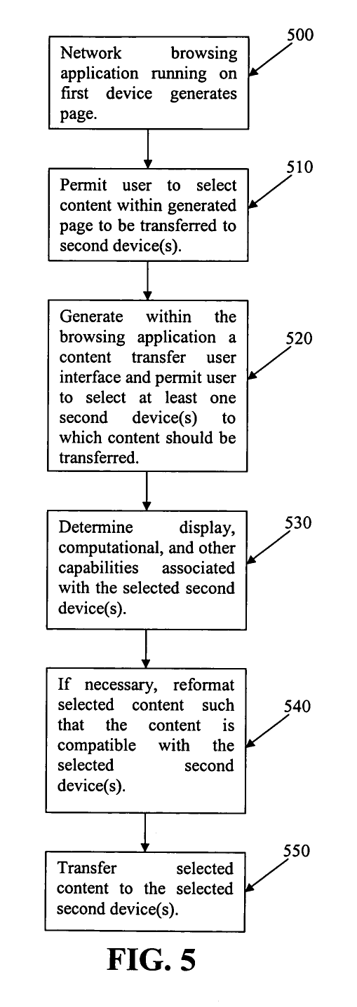

FIG. 5 is a flow diagram illustrating an exemplary process through which content can be transferred from a first device to a second device. In FIG. 5, the network browsing application generates a page on a first device (Block 500), and the user is able to select content from the page which is to be transferred to the second device (Block 510). A content transfer user interface is then generated within the network browsing application (Block 520) which allows the user to select at least one second device to which the content is to be transferred. In the embodiment illustrated in FIG. 5, the network carrier or provider supplying communications service to the second device, as well as the computational, display, and other capabilities associated with the selected second device or devices are determined (Block 530). The capabilities of a given device may be determined by requesting such information from the user, from stored attributes associated with the device, by polling the device, or by other such means. This permits the content to be reformatted to meet the capabilities of the selected second devices (Block 540). The reformatted content is then transferred to the second devices (Block 550). Although illustrated as occurring prior to the transfer step, the reformatting step may be performed by the SMS server, its equivalent, or another intermediary server or service after the content has left the first device. Still further, although the content may be reformatted to meet the display, processing, bandwidth, or other capabilities of a second device, the overall “look and feel” of the content may be preserved, thereby simplifying navigation as users utilize different versions of the content on different devices.

Further details and features which can be implemented in connection with SMS messaging from a web page will be understood from U.S. patent application Ser. No. 10/951,982, filed Sep. 28, 2004, the entire disclosure of which is incorporated herein by reference.

While the disclosure has shown and described certain embodiments, it will be understood by those skilled in the art that various changes in form and details may be made therein without departing from the spirit and scope of the invention.

We claim:

1. A method of transferring content between a plurality of devices, comprising:
receiving from a user of a first device an identification of text available within a network browsing application which is to be transferred to at least one second device;
causing at least one menu to be opened within the network browsing application;
permitting a user to select from the at least one menu the at least one second device to which the identified content is to be transferred; and
causing the identified content to be communicated for further transfer to the at least one second device using Short Messaging Service.

2. The method of claim 1, wherein content selection is performed by dragging a cursor across the content.

3. The method of claim 2, further comprising reformatting the text in accordance with at least one attribute associated with the second device.

4. The method of claim 3, wherein the at least one attribute comprises the display resolution of the at least one second device.

5. The method of claim 1, wherein the content of the at least one menu is generated based on an XML feed.

6. A method of transferring content between a plurality of devices, comprising:
receiving from a user of a first device an identification of text available within a network browsing application which is to be transferred to at least one second device;
causing a new page to be displayed within the network browsing application, wherein the new page includes a plurality of recipient devices;
permitting a user to select from plurality of recipient devices the at least one second device to which the identified content is to be transferred; and
causing the identified content to be communicated for further transfer to the at least one second device using Short Messaging Service.

7. The method of claim 6, wherein content selection is performed by dragging a cursor across the content.

8. The method of claim 6, wherein the new page is opened in a new network browsing application window.

9. The method of claim 6, further comprising reformatting the text in accordance with at least one attribute associated with the second device.

10. The method of claim 9, wherein the at least one attribute comprises the display resolution of the at least one second device.

11. The method of claim 6, wherein the content of the at least one menu is generated based on an XML feed.

12. A method of transferring content between a plurality of devices, comprising:
receiving from a user of a first device an identification of content available within a network browsing application which is to be transferred to at least one second device;
causing a content transfer user interface to be opened within the network browsing application;
receiving an identification of the at least one second device to which the identified content is to be transferred from a user of the content user interface; and
causing the identified content to be communicated for transfer to the at least one second device.

13. The method of claim 12, wherein the content is a pointer.

14. The method of claim 3, wherein the pointer is a uniform resource locator.

15. The method of claim 12, wherein the content comprises plain text.

16. The method of claim 12, wherein the content comprises non-text content.

17. The method of claim 12, wherein the content has been identified by the user selecting the content in the network browsing application.

18. The method of claim 19, wherein content selection is performed by dragging a cursor across the content.

19. The method of claim 12, wherein the content transfer user interface is a new network browsing application window.

20. The method of claim 12, wherein the content transfer user interface comprises at least one menu.

21. The method of claim 12, further comprising identifying at least one attribute associated with the at least one second device.

22. The method of claim 21, wherein the at least one attribute is comprised of the carrier providing service to the second device.

23. The method of claim 21, wherein the at least one attribute is comprised of an indication of the computing capabilities of the second device.

24. The method of claim 21, further comprising reformatting the identified content in accordance with the at least one attribute associated with the second device.

25. The method of claim 21, wherein the at least one attribute associated with the at least one second device is received from the user.

26. The method of claim 21, wherein the at least one attribute associated with the at least one second device is determined by polling.

27. The method of claim 26, wherein the polling comprises sending a request for information to the at least one second device.

28. The method of claim 26, wherein the polling comprising sending a request for information to a network service provider associated with the at least one second device.

29. The method of claim 26, wherein the at least one attribute comprises a device capability attribute.

30. The method of claim 29, wherein the device capability attribute comprises the display resolution of the at least one second device.

31. The method of claim 29, wherein the device capability attribute comprises the storage capacity of the at least one second device.

32. The method of claim 12, wherein the identifying at least one second device step comprises selecting at least one device from a plurality of predefined devices.

33. The method of claim 32, wherein the device definitions comprise a recipient name, a network address, and at least one device capability attribute.

34. The method of claim 12, wherein the identified content is communicated for transfer via Short Messaging Service.

35. A computer-readable storage medium containing a set of instructions for a general purpose computer for transferring content between a plurality of devices, comprising:
code for presenting a network browsing application on a first device;
code for permitting a user of the first device to identify content within the network browsing application to be transferred to at least one second device;
code for generating a content transfer user interface within the network browsing application;
code for permitting the user of the first device to identify the at least one second device via the content transfer user interface; and,
code for causing the identified content to be communicated for transfer to the second device.

36. The computer-readable storage medium of claim 35, wherein the code for identifying content permits the user to select the content in the network browsing application.

37. The computer-readable storage medium of claim 36, wherein content selection is performed by dragging a cursor across the content.

38. The computer-readable storage medium of claim 35, wherein the content transfer user interface comprises a new network browsing application window.

39. The computer-readable storage medium of claim 35, wherein the content transfer user interface comprises at least one menu.

40. The computer-readable storage medium of claim 35, further comprising code for identifying at least one attribute associated with the second device.

41. The computer-readable storage medium of claim 40, wherein the at least one attribute is comprised of the carrier providing service to the second device.

42. The computer-readable storage medium of claim 40, wherein the at least one attribute is comprised of an indication of the computing capabilities of the second device.

43. The computer-readable storage medium of claim 40, wherein the at least one attribute is comprised of an indication of the display capabilities of the second device.

44. The computer-readable storage medium of claim 40, further comprising code for reformatting the identified content in accordance with the at least one attribute associated with the second device.

45. The computer-readable storage medium of claim 35, wherein the code for identifying at least one second device comprises code for permitting a user to select at least one device from a plurality of predefined devices.

46. The computer-readable storage medium of claim 35, wherein the device definitions comprise a recipient name, a network address, and at least one device capability attribute.

47. The computer-readable storage medium of claim 35, wherein the identified content is communicated for transfer via Short Message Service.

48. A user interface for facilitating the transfer of content between a plurality of devices, comprising:
first code for presenting a network browsing application on a first device, wherein the first code permits a user of the network browsing application to identify content within the network browsing application to be transferred to at least one second device;
second code for generating a content transfer user interface within the network browsing application upon identification of the content to be transferred to the second device, wherein the content transfer user interface permits the user to identify the at least one second device; and,
third code for causing the identified content to be communicated for transfer to the identified at least one second device.

49. The computer-readable storage medium of claim 48, wherein the code for identifying content permits the user to select the content in the network browsing application.

50. The computer-readable storage medium of claim 49, wherein content selection is performed by dragging a cursor across the content.

51. The computer-readable storage medium of claim 48, wherein the content transfer user interface is a new network browsing application window.

52. The computer-readable storage medium of claim 48, further comprising code for identifying at least one attribute associated with the second device.

53. The computer-readable storage medium of claim 52, wherein the at least one attribute is comprised of the carrier providing service to the second device.

54. The computer-readable storage medium of claim 52, wherein the at least one attribute is comprised of an indication of the computing capabilities of the second device.

55. The computer-readable storage medium of claim 52, further comprising code for reformatting the identified content in accordance with the at least one attribute associated with the second device.

56. The computer-readable storage medium of claim 48, wherein the content transfer user interface comprises at least one menu.

57. The computer-readable storage medium of claim 48, wherein the code for identifying at least one second device comprises code for selecting at least one device from a plurality of predefined devices.

58. The computer-readable storage medium of claim 57, wherein the device definitions comprise a recipient name, a network address, and at least one device capability attribute.

59. The computer-readable storage medium of claim 48, wherein the identified content is communicated for transfer via Short Message Service.

60. A computer-readable storage medium containing a set of instructions for a general purpose computer for operating with a network browsing application to transfer content between a plurality of devices, comprising:
code for identifying content within an arbitrary web page displayed in a network browsing application for transfer to at least one second device;
code for generating a content transfer user interface within the network browsing application;
code for permitting the user of the first device to identify the at least one second device via the content transfer user interface; and,
code for causing the identified content to be communicated for transfer to the second device.

61. The computer-readable storage medium of claim 60, wherein the code for identifying content permits the user to select the content in the network browsing application.

62. The computer-readable storage medium of claim 61, wherein content selection is performed by dragging a cursor across the content.

63. The computer-readable storage medium of claim 62, wherein the content transfer user interface is a new network browsing application window.

64. The computer-readable storage medium of claim 62, further comprising code for identifying at least one attribute associated with the second device.

65. The computer-readable storage medium of claim 64, wherein the at least one attribute is comprised of the carrier providing service to the second device.

66. The computer-readable storage medium of claim 64, wherein the at least one attribute is comprised of an indication of the computing capabilities of the second device.

67. The computer-readable storage medium of claim 64, further comprising code for reformatting the identified content in accordance with the at least one attribute associated with the second device.

68. The computer-readable storage medium of claim 60, wherein the content transfer user interface comprises at least one menu.

69. The computer-readable storage medium of claim 60, wherein the code for identifying at least one second device comprises code for selecting at least one device from a plurality of predefined devices.

70. The method of claim 69, wherein the device definitions comprise a recipient name, a network address, and at least one device capability attribute.

71. The method of claim 60, wherein the identified content is communicated for transfer via Short Message Service.
